(19) United States
(12) Patent Application Publication
(10) Pub. No.: US 2019/0281380 A1
(43) Pub. Date: Sep. 12, 2019

(54) Novel Headphone with canopy cover

(71) Applicant: Nghia Tran, Edmonton (CA)

(72) Inventor: Nghia Tran, Edmonton (CA)

(21) Appl. No.: 15/912,709

(22) Filed: Mar. 6, 2018

(51) Int. Cl. H04R 1/10

(52) U.S. Cl. CPC H04R 1/1091; H04R 5/033; H04R 1/1008; H04R 1/1083

(57) ABSTRACT

The present invention provides a headphone system having a canopy incorporated there with whereby said canopy is adjustable into either a fully retracted position underneath the headphone headband or an extended position covering some portion of the head of a user.

### BACKGROUND OF THE INVENTION

Personalized headphones have existed for approximately 100 years. Companies continue to innovate in many ways. However, there is an area where the personalization is lacking. This is when one desires not only personalized sound but a personalized space along with the personalized sound.

The present invention addresses this need.

### SUMMARY OF THE INVENTION

In one embodiment, the present invention is a headset with insulated sound properties to block out sound and including a canopy that is constructed and arranged to be extended to cover as desired and also retracted and concealed within the headband.

In one embodiment, the present invention the canopy will also protrude out forward to block out sight and protects from environmental distress when needed.

The canopied headset configuration allows the user the ability to isolate their self from distressful environment.

This isolation includes shielding from excessive sunlight, rain, and social population. An example is blocking out excessive noise and light on a commercial airplane. The canopy headset also aids the user with sleep in unfavorable environments.

The present invention allows a user to take nap during the busy hustle of modern society. This is a perfect feature for the ever growing number of night shift workers. They would be able to get good sleep during the day when the sun is piercing through a window and/or cotenants making noises.

The canopy headset also allows the user to quickly focus to achieve a meditative state. Furthermore the headset may contain audio capabilities via speakers within the earpiece. This technology can be integrated with Bluetooth.

As generally understood, that for the present invention can be configured as desired including but not limited to anyone or combinations of hardwired to a sound source, wireless transmission from a sound source to the headphones, hardwire charging, USB charging, wireless charging, and commendations thereof.

In one embodiment, the material used to construct the canopy is customizable and includes, but is not limited to: high density transparent plastic canopy construction/or replacement configured with safety features allowing the user to have instant face shielding capabilities to avoid dust and debris.

### BRIEF DESCRIPTION OF THE SEVERAL VIEWS OF THE DRAWINGS

FIG. 1 is a side view of one embodiment of the present invention affixed on the head of a user.

FIG. 2 is a side view of one embodiment of the present invention with the canopy in a fully extended position.

FIG. 3 is a side perspective view of one embodiment of the present invention with the canopy in an extended position.

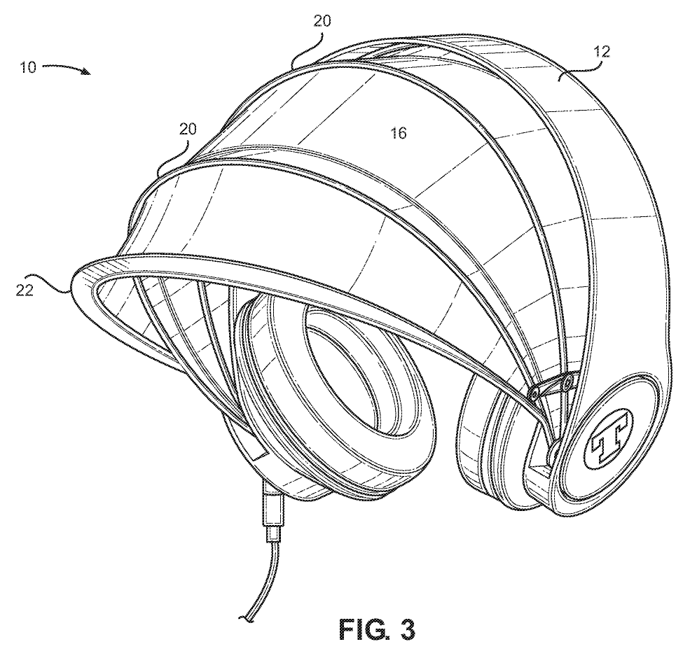

FIG. 4 is a side perspective view of one embodiment of the present invention with the canopy in a retracted position.

In one embodiment, the invention is a headphone system comprising:

a headband having two opposing earpieces;

a canopy constructed and arranged to have a first retracted position underneath that headband and a second extended position extending about the periphery of a user's head.

In one embodiment, the invention further comprises a locking mechanism to selectively position and secure said canopy into a desired degree of extension or secure into a fully retracted position.

In one embodiment, the canopy has a terminal member that defines the degree of extension.

In one embodiment, the invention further comprises said canopy being constructed and arranged with a fully retracted position that is completely underneath and within the periphery of said headband.

In one embodiment, the invention is a headphone system consisting essentially of:

a headband having two opposing earpieces;

a canopy constructed and arranged to have a first retracted position underneath that headband and a second extended position extending about the periphery of a user's head;

a locking mechanism to selectively position and secure said canopy into a desired degree of extension or secure into a fully retracted position, wherein the canopy has a terminal member that defines the degree of extension; and the canopy being constructed and arranged with a fully retracted position that is completely underneath and within the periphery of said headband.

### DETAILED DESCRIPTION OF THE PREFERRED EMBODIMENT

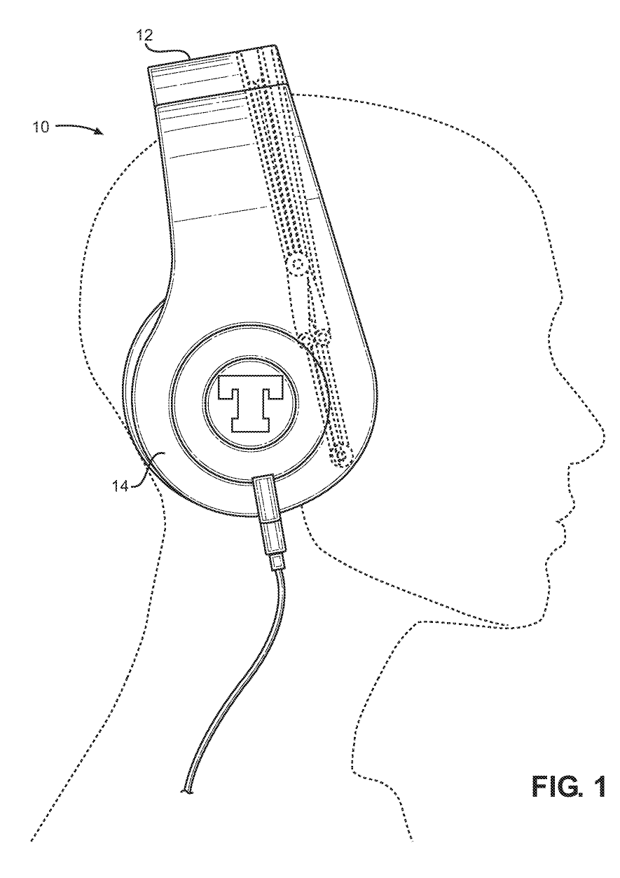

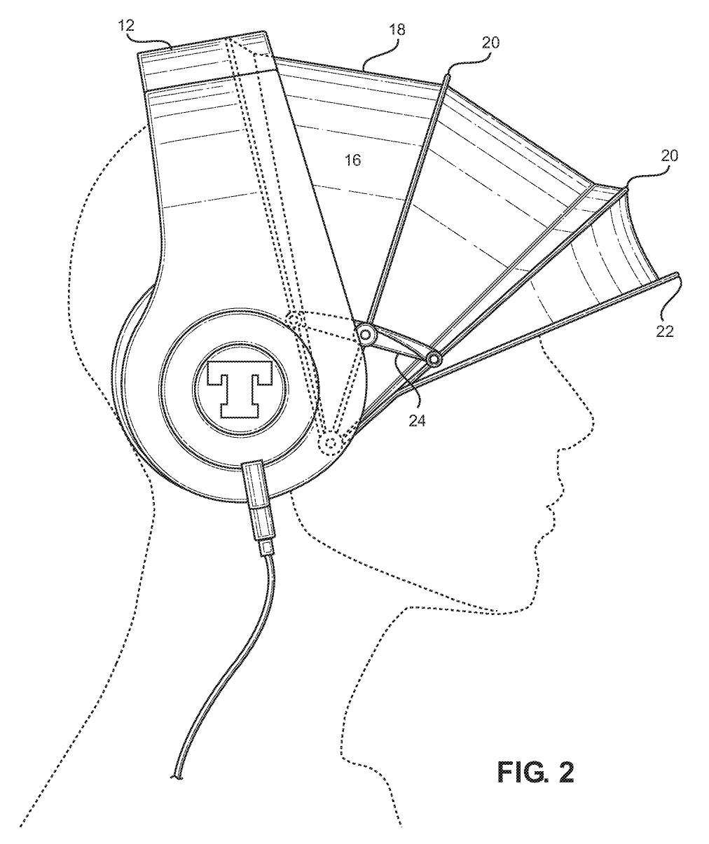

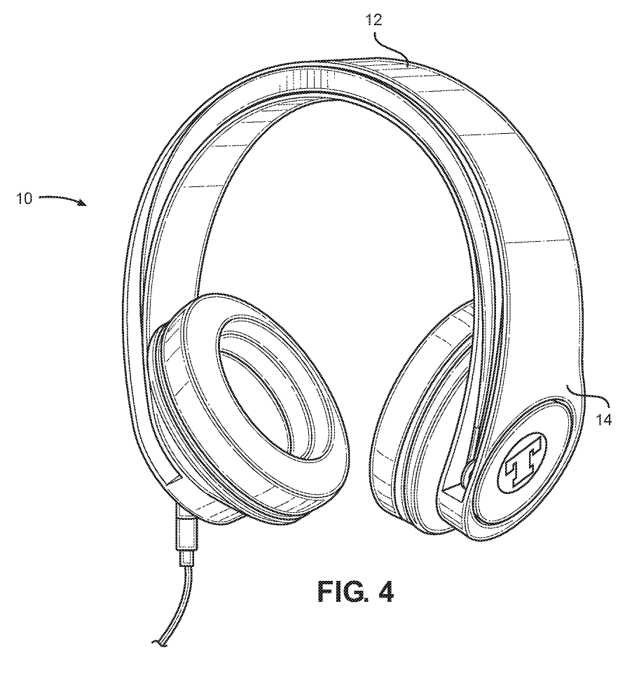

The present invention includes headphone assembly 10 having a headband 12 constructed and arranged with opposing earpieces 14 on opposite ends. Canopy 18 is formed by canopy material 16 that is positioned and held by canopy supports 20 and canopy terminating support 22. Extension mechanism 24 is constructed and arranged such that terminating support 22 and the entirety of canopy material 16 is moved into an extended position as shown in FIG. 2 and three or a retracted position as shown in FIGS. 1 and 4. FIG. 1 is a side partial cross-section demonstrating that in a fully retracted position the entirety of cavity material 16 is positioned within and underneath the periphery of headband 12. As generally understood, the retracting position underneath the headband will essentially provide a configuration whereby the canopy is substantially within the headband when worn.

Although FIG. 1 shows a fully retracted position, and FIG. 2 shows a fully extended position, it is contemplated in the present invention that canopy 18 be constructed and arranged for any degree of extension desired by a user. That is to say, a user is not limited to fully extended or fully retracted. A user can have a partially extended canopy as desired.

Additionally, although the figures show the canopy in a particular degree of extension, it is contemplated in one embodiment of the present invention that the canopy cover 50% or more of the users face to provide significant privacy and seclusion as desired.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1. A headphone system comprising:
a headband having two opposing earpieces;
a canopy constructed and arranged to have a first retracted position completely underneath and within the periphery of said headband and a second extended position extending about the periphery of a user's head, said canopy further formed as an opaque canopy formed to block out light when said canopy is in said extended position.

2. The system of claim 1 further comprising a locking mechanism to selectively position and secure said canopy into a desired degree of extension or secure into a fully retracted position.

3. The system of claim 1 wherein said canopy has a terminal member that defines the degree of extension.

4. (canceled)
